(19) United States
(12) Patent Application Publication
(10) Pub. No.: US 2018/0022007 A1
(43) Pub. Date: Jan. 25, 2018

(54) METHOD FOR MONITORING AND CONTROLLING A TWIN-SCREW EXTRUDER, AND TWIN-SCREW EXTRUDER

(71) Applicant: CLEXTRAL, Firminy (FR)

(72) Inventors: Daniel DURAND, BAS EN BASSET (FR); Thierry JAROUSSE, SAINT MAURICE EN GOURGOIS (FR)

(73) Assignee: CLEXTRAL, Firminy (FR)

(21) Appl. No.: 15/547,927

(22) PCT Filed: Feb. 2, 2016
(86) PCT No.: PCT/EP2016/052139

§ 371 Date: Aug. 1, 2017

(30) Foreign Application Priority Data
Feb. 3, 2015 (FR) 1550835

(51) Int. Cl. B29C 47/92; B29C 47/40; B29C 47/08

(52) U.S. Cl. CPC B29C 47/92; B29C 47/0816; B29C 47/402; B29C 2947/922; B29C 2947/924; B29C 2947/92409; B29C 2947/9259; B29C 2947/926; B29C 2947/92704; B29C 2947/92695; B29C 2947/92723; B29C 2947/92857

(57) ABSTRACT

In the disclosed method, in order to control an extruder including two intermeshing screws for driving a material to be extruded, the following steps are performed while a material to be extruded is being processed by the extruder: constantly measuring the viscosity of the material in the flow of the material in the extruder, and adjusting the extruder in accordance with the viscosity measurement. In order to adjust the extruder in an effective and efficient manner, the rate at which the extruder is filled with material along the intermeshing screws is modified by adjusting, downstream from the screws, a flow cross-section for the material in accordance with the viscosity measurement.

The present invention relates to a twin-screw extruder, and a method for monitoring and controlling such a machine.

The invention examines so-called twin-screw extruders, which comprise a sheath, generally thermo-regulated, inside which two intermeshing screws are rotated around themselves such that they drive a material to be extruded from an upstream part of the sheath to a downstream end of the sheath where the material is then forced to flow through an output device that often includes a shaping channel for the extruded material. In such an extruder, the material undergoes both a mechanical transformation, by pressurizing and shearing via the screws, and a thermal transformation, by adjusting the temperature along the sheath.

Controlling such an extruder is delicate in that the quality of the extruded product depends not only on the mastery of the thermomechanical adjustment parameters of the extruder, which are, inter alia, the rotation speed of the screws, the geometry of the screws, the temperature imposed on the sheath and the intake flow rate of the raw material in the extruder, but also the quality of the raw material introduced into the extruder: in fact, the quality of each of the ingredients of this raw material may vary, in particular due to their physicochemical variability (moisture content, fat content, particle size, etc.), their origin, or even their storage conditions, such that the quality of the extruded material is affected by these factors even with a constant adjustment of the extruder.

To provide a response to this issue, it is known to take samples of the extruded product regularly, then to analyze them a posteriori: it will be understood that this approach does not make it possible to adjust the extruder in real time.

It is also known to try to adjust the behavior of the extruder based on the so-called specific mechanical energy (SME) property. The SME corresponds to the energy supplied by the motor driving the screws of the extruder, relative to the mass unit of extruded material. Thus, the SME reflects the level of mechanical transformation of the material being extruded. The prior art teaches that by continuously measuring the SME, it is possible to regulate the extruder by adjusting, at the running part of the screws, a passage section of the material being extruded: the idea is to “loop”, in other words to slave variations of the passage section for the material being extruded, with the SME measurement. However, this solution only provides a very partial response to the issue described above. Indeed, the SME only provides a partial overview of the quality of the product leaving the extruder. In particular, the residence time of the material in the extruder is not taken into account by the SME, whereas it directly affects the quality of the extruded finished product.

In turn, US 2004/0020272 proposes to take, during the extrusion of the polymer by a twin-screw extruder, rheological measurements of the material processed by the extruder, these measurements being in line, i.e., in the stream of material inside the extruder. To that end, pressure and temperature sensors are arranged on the extruder, more specifically at an outlet channel of this machine, as well as at the space separating the downstream end of the screws and the channel. The various measurements are used to calculate, inter alia, the viscosity of the material in the extruder. More globally, these measurements are processed in real-time to monitor the quality of the extruded polymer, and to adjust the extruder, without, however, US 2004/0020272 explaining how to carry out this adjustment.

DE 44 33 593 adopts an approach similar to US 2004/2020272: an extruder incorporates, between the tip of its screw and an output channel, a viscometer that is made up of several pressure sensors following one another in the flow direction of the processed material. The information delivered jointly by these pressure sensors is representative of the viscosity of the material flowing between the screw tip and the output channel. This information is used, in real-time, to adjust the working temperature and SME of the extruder.

The aim of the present invention is to offer a more effective and more thorough response to the issue of monitoring and controlling extruders in order to obtain a final extruded material with controlled quality.

To that end, the invention relates to a method for monitoring and controlling an extruder, the extruder comprising two intermeshing screws for driving a material to be extruded, the method comprising, while a material to be extruded is processed by the extruder:
continuously measuring the viscosity of the material in a flow of said material in the extruder, and
adjusting the extruder from corresponding material viscosity measurement results, so that a material filling level of the extruder, at which the extruder is filled by the material along the intermeshing screws, is modified by adjusting, downstream from these screws, a passage section for the material based on the material viscosity measurement results.

One of the ideas at the base of the invention is to use the measurement for the viscosity of the material in the extruder, the viscosity being a relevant marker of the rheological variations of the material being extruded. This measurement is provided to be in-line, i.e., in the stream of the material inside the extruder: indeed, to provide real-time adjustment, the evolution of the viscosity must be assessed continuously for the material being extruded. Furthermore, the viscosity is the resultant of shearing, pressure, residence time, temperature, etc. effects applied to the extruded material. Indeed, the viscosity corresponds to the flow resistance of a material under the influence of at least one stress such as shearing, pressure, gravity, etc.: when the viscosity increases, the capacity of the fluid to flow decreases. The invention thus proposes continuously measuring the viscosity of the material being extruded and using this continuous measurement to adjust, in real-time, a passage section for the material leaving the extruder, i.e., for the material in this machine downstream from its screws: by acting on this passage section of the extruder while all other things are equal, one modifies the filling level of the machine with the material being extruded accordingly, more specifically its filling level along its intermeshing screws that cause the material to advance within the machine, which causes the viscosity of the material being extruded to vary accordingly. In particular, it will be understood that, for example, by reducing the passage section downstream from the intermeshing screws, one increases the quantity of material upstream from the restriction, i.e., at the screws; this amounts to saying that one increases the filling level of the extruder along these screws; and, under the action of these screws, the material is better sheared, which decreases its viscosity. Thus, by having an image beforehand of the viscosity value for the product to be obtained at the output of the extruder, one is capable, when the viscosity measurement deviates from the desired viscosity value, of returning to this desired viscosity value by adjusting this passage section and thus compensating, with a corresponding actuator for controlling the extruder, for the effects of the aforementioned irregularities of the raw material. One then keeps the quality of the extruded material substantially constant, in terms of density, characteristic dimensions, degree of cooking, texture, etc. More generally, by mastering the viscosity of the material during extrusion, one has an overall picture of the quality of the final extruded product. Advantageously, one is thus even capable, subject to this adjustment of the passage section downstream from the screws, slaved to the in-line viscosity measurement, of compensating the effects of the wear of the extruder, in particular the effects of the evolution of the shearing rate resulting from this wear.

More generally, the control method according to the invention makes it possible, inter alia, to:
maintain a consistent quality of the extruded end product continuously;
avoid losses of extruded material, since the in-line viscosity measurement allows instantaneous information on variations of the material being extruded;
instantaneously view the fluctuations of the extrusion conditions, in particular the evolution of the raw material, any incidents in the extrusion process and potential technical problems in the extruder;
use the extruder for longer, since instead of changing worn parts, it is possible to increase the residence time of the material such that it is subject to a shearing rate equal to that of a new machine, the screws and sheath being able to continue to be used despite their natural wear due to friction; and
test and develop, in a controlled and repeatable manner, new characteristics for the extruded products.

According to a preferred embodiment of the method according to the invention, the extruder further comprises:
a sheath inside which the intermeshing screws are rotated and the material advances under the action of these screws, and
an output device, which is arranged at a downstream end of the sheath and in a flow channel of which the material leaving the sheath is forced to flow under the action of the intermeshing screws.

In that way, in order to adjust the extruder, the material filling level in the sheath is adjusted by adjusting a passage section of the flow channel.

In practice, the viscosity may be measured for the material leaving the sheath, in the flow channel of the output device.

According to an advantageous optional arrangement, the extruder is adjusted by further adjusting, based on the material viscosity measurement results, at least one behavior parameter of the extruder chosen from among:
rotation speed of the screws,
temperature imposed on a sheath in which the driving screws are rotated,
composition of the ingredient(s), solid and/or liquid, introduced into the extruder,
flow rate of the ingredient(s), solid and/or liquid, introduced into the extruder, and
degassing of the material in the extruder.

In that way, one or several actuators for controlling the extruder, other than the actuator modifying the passage section of the material in the extruder downstream from the screws of the latter, can be implemented in combination with the actuation for adjusting this passage section, still from the in-line viscosity measurement. The monitoring and control performance of the extruder are improved as a result.

In practice, the nature of the extruded material is irrelevant: the invention relates to the extrusion of agro-food and non-agro-food materials, such as plastic, chemical, pharmaceutical, etc. materials. As a result, the method according to the invention is particularly advantageously applicable when the material to be extruded is non-Newtonian, in particular food. A fluid is considered here to be non-Newtonian when its viscosity depends on the shear rate. It will be understood that for such a non-Newtonian material, no linear laws exist relative to its viscosity: the invention makes it possible, however, to effectively adjust the twin-screw extruder by acting on its filling level, such that, all along the screws, the material is sheared, or more generally, stressed, therefore affecting the viscosity of all of the material, except for the marginal, and therefore negligible, portions of the latter.

The invention also relates to an extruder, comprising:
a sheath inside which two intermeshing screws are rotated to cause a material to be extruded to advance in the sheath,
measuring means for measuring the viscosity of the material in a flow of the material in the extruder,
an output device, which is arranged at the downstream end of the sheath and in a flow channel of which the material leaving the sheath is forced to flow under the action of the intermeshing screws, and
a varying device for varying a passage section of the flow channel so as to modify a material filling level at which the sheath is filled by the material.

According to additional advantageous features of the extruder according to the invention:
The varying device comprises a closure member arranged movably in the flow channel to close off the flow channel variably.
The closure member comprises, a flap for variably closing off the flow channel, the flap being arranged across the flow channel so as to pivot around an axis substantially perpendicular to flow direction of the material in the flow channel.
The measuring means are arranged upstream from the closure member.
The varying device comprises a control unit that is slaved based on a signal provided by the measuring means.
The varying device comprises a manual control member.
The measuring means comprise a viscosity measuring sensor, which is arranged in the flow channel of the output device and which measures the viscosity of the material flowing in the flow channel.
The flow channel is defined in a dedicated modular case of the output device, which fixedly carries the viscosity measuring sensor and which carries at least part of the varying device.
The output device further comprises, at an upstream end thereof, a plate for connecting with a downstream end of the sheath, the plate being arranged upstream from the modular case.
The output device further comprises, at a downstream end thereof, a die for shaping the material leaving the output device, the die being arranged downstream from the modular case.

Of course, the invention applies, without limitation, to various twin-screw extruders, whether the two screws of the latter are contra-rotating or co-rotating.

The invention will be better understood upon reading the following description, provided solely as an example and done in reference to the drawings, in which:

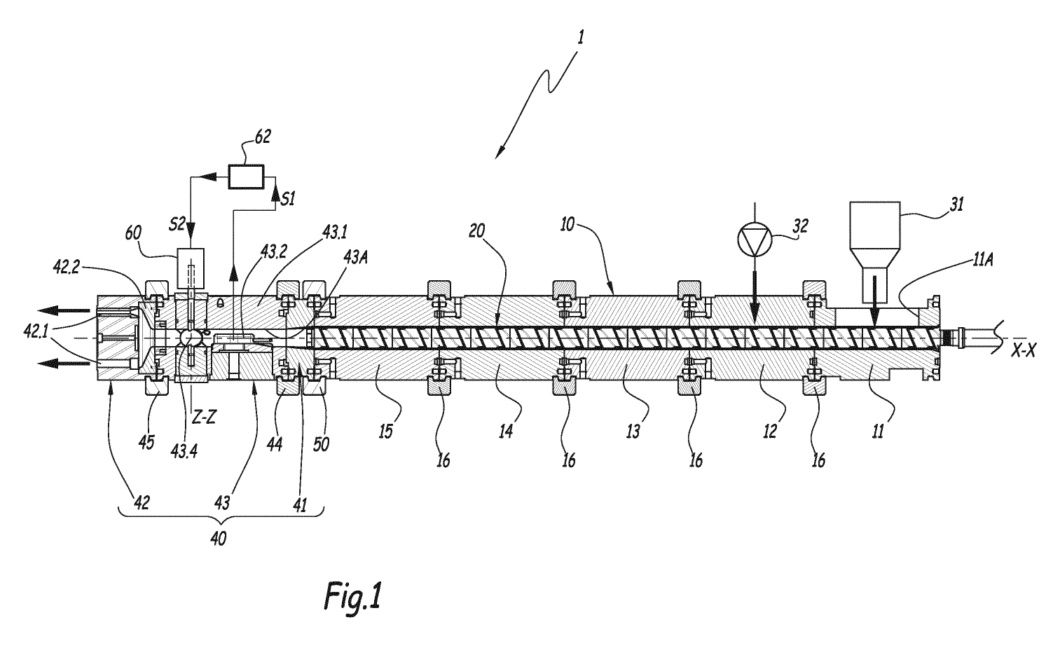

FIG. 1 is a schematic longitudinal sectional view of an extruder according to the invention;

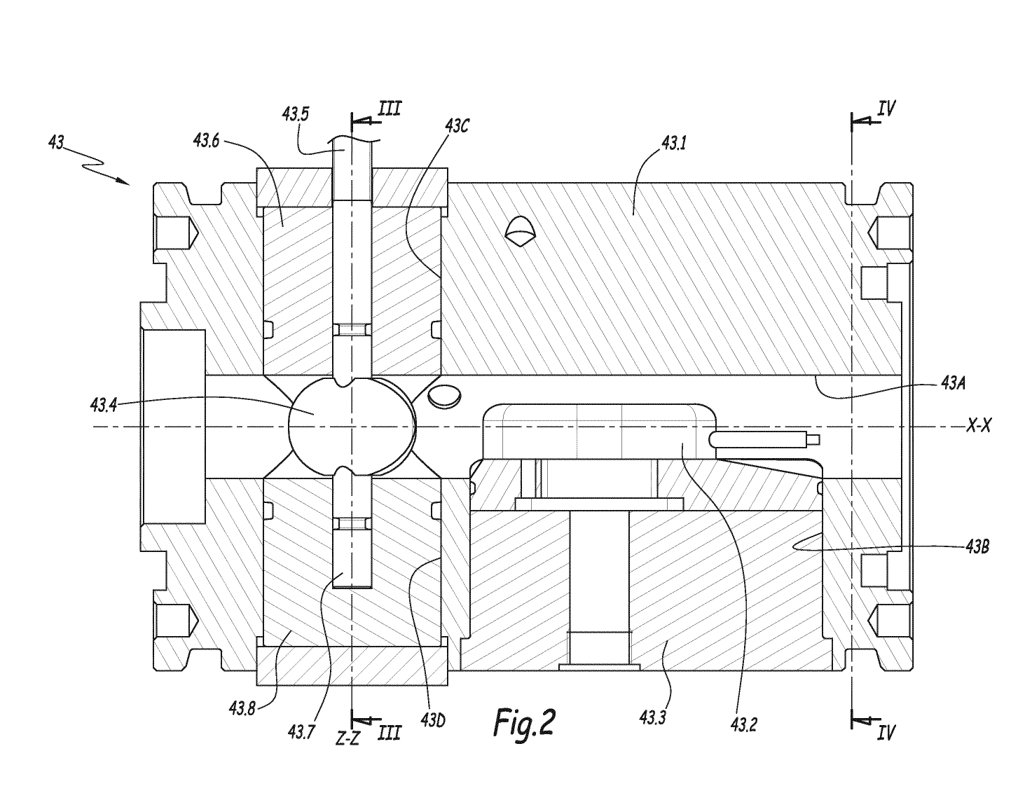

FIG. 2 is an enlarged view of only part of the machine of FIG. 1;

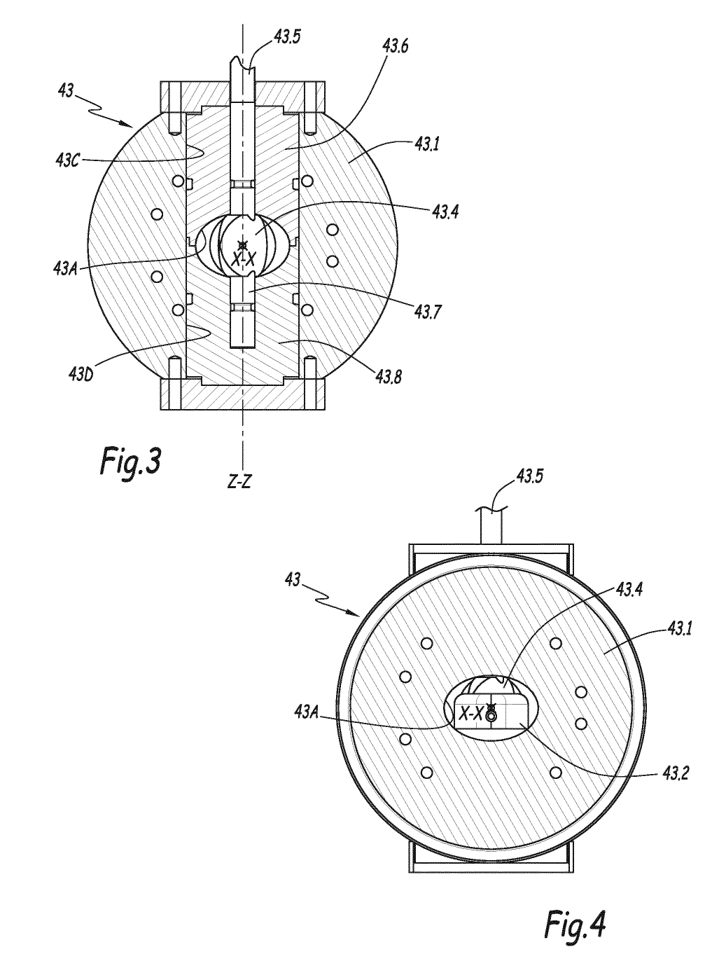

FIGS. 3 and 4 are sectional views along lines III-III and IV-IV of FIG. 2; and

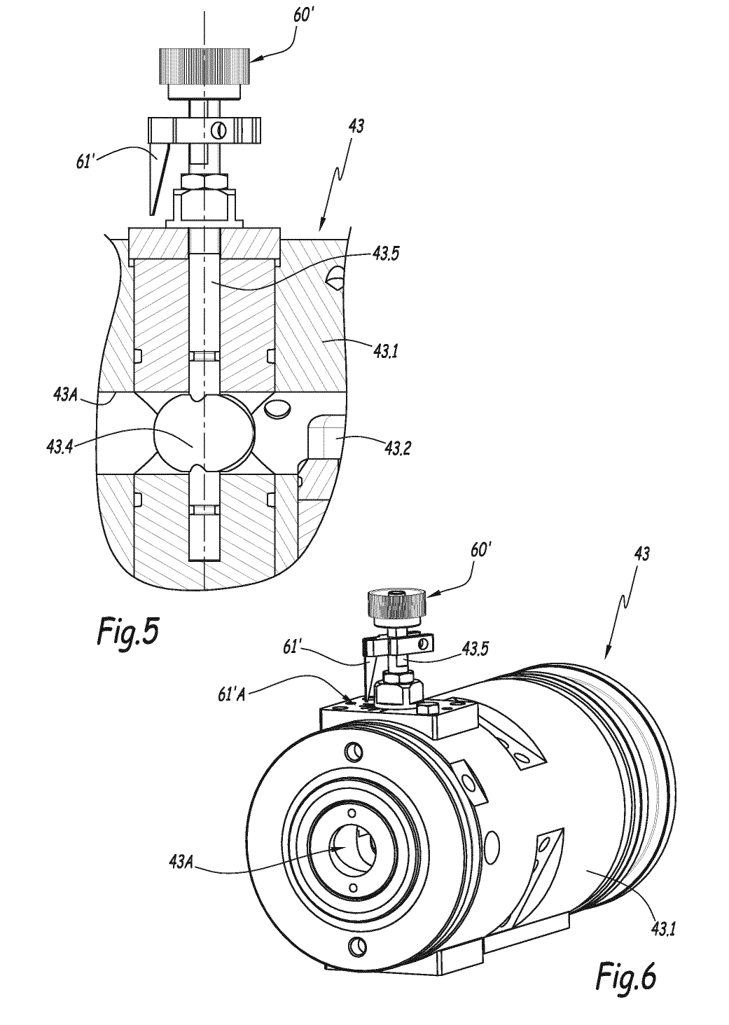

FIGS. 5 and 6 illustrate an alternative of the aforementioned part of the extruder, according to the invention, FIG. 6 being a perspective view of this part of the extruder, while FIG. 5 is a partial longitudinal sectional view thereof, in a plane similar to that of FIG. 2.

FIG. 1 schematically shows an extruder 1, commonly called “twin-screw extruder”.

This extruder 1 comprises an elongate sheath 10, which extends along and is centered on geometric axis X-X. Inside the sheath 10, two screws 20 extend parallel to the axis X-X, while being received in a complementary longitudinal bore of the sheath, centered on the axis X-X. These two screws 20 extend on either side of the axis X-X, while being intermeshing, the aforementioned bore of the sheath 10 having a bilobed transverse profile. Each screw 20 is rotated around itself, around its central axis, by a motor unit, not shown in FIG. 1, mechanically engaged with an upstream end of the screw, i.e., that on the right in FIG. 1, emerging outside the sheath 10.

The screws 20 of the extruder 1 are designed, due to their threaded profile, to drive the material to be extruded along the axis X-X, from an upstream part of the sheath 10, in which the ingredient(s) of this material are introduced into the aforementioned bore of the sheath, to the downstream end of the sheath 10, the terms “upstream” and “downstream” being oriented in the direction of advance of the material inside the sheath under the action of the screws 20, this direction of advance being from right to left in FIGS. 1 and 2. Furthermore, in a manner known in itself and as mentioned in the introduction of the present document, the screws 20 are designed so as, in addition to driving the material to be extruded, to shear and exert pressure on this material, so as to mechanically transform it. This aspect of the extruder 1 being well known in the art, it will not be described here in more detail.

The sheath 10 comprises several modular elements following one another along the axis X-X, here five of them, respectively referenced 11 to 15 from upstream to downstream. Each of the elements 11 to 15 inwardly defines a corresponding part of the central longitudinal bore of the sheath 10, these bore parts being in the extension of one another, along the axis X-X, in the assembled state of the elements 11 to 15, like in FIG. 1. In practice, as shown in FIG. 1, the elements 11 to 15 are assembled in pairs by locking collars 16.

In the example embodiment considered in FIG. 1, the element 11 furthest upstream makes it possible to insert, inside its central bore part, one or several at least partially solid ingredients of the material to be extruded. To that end, in a manner known in itself and not outlined here, this element 11 is provided with a through orifice 11A, which, transversely to the axis X-X, opens the central bore part of this element 11 to the outside and in which a hopper 31 supplying the aforementioned at least partially solid ingredient(s) emerges. Likewise, in the example considered here, the element 12 is designed to introduce, from the outside, one or several liquid ingredients inside the corresponding central bore part. In practice, in a manner known in itself and not described in detail, the element 12 is provided with one or several through orifices, which, transversely to the axis X-X, connect the aforementioned bore part to one or several injection pumps 32 for this or these liquid ingredient(s). More generally, it will be understood that, among the elements 11 to 15 of the sheath 10, one or several of them make it possible to introduce, inside the central longitudinal bore of the sheath 10, one or more ingredients of the material to be extruded by the extruder 1.

The extruder 1 also comprises an output device 40, which is arranged at the downstream end of the sheath 10. The material leaving the sheath 10 is, under the action of the screws 20, forced to flow through the output device 40, from which the extruded material emerges outside the machine. In the example embodiment of the figures, the output device 40 comprises three separate modular parts, namely:
at the upstream end of this device 40, a front plate 41 connecting with the downstream end of the sheath 10,
at the downstream end of the device 40, a die 42 for shaping the material leaving the device 40, and
interposed between the plate 41 and the die 42, a module 43 connecting the plate 41 to the die 42.

The plate 41 is securely attached, for example by a locking collar 50, to the downstream end of the element 15, furthest downstream, of the sheath 10. In a manner known in itself, this plate 41 inwardly defines a through bore, which is centered on the axis X-X, which extends in the extension, along this axis, of the central bore part of the element 15, and inside which the free downstream end of each screw 20 is received. The central bore of this plate 41 channels the material leaving the sheath 10 pushed in the downstream direction by the screws 20. Non-limitingly, in the example considered in FIG. 1, the central bore of the plate 41 advantageously converges in the downstream direction, in particular so as to maximize the filling of the downstream end of this bore by the material leaving the sheath 10.

The module 43, which will be described in more detail below, comprises a primary case 43.1, which is inserted, in the direction of the axis X-X, between the downstream end of the plate 41 and the upstream end of the die 42, while being fastened thereto by respective collars 44 and 45, and which inwardly defines a material flow channel 43A from the downstream end of the plate 41 to the upstream end of the die 42. This flow channel 43A traverses the case 43.1 axially all the way through, connecting the opposite axial ends thereof, while being substantially centered on the axis X-X and while thus extending in the axial extension of the central bore of the plate 41 and the central longitudinal bore of the sheath 10, as clearly shown in FIG. 1.

In a manner known in itself, the die 42 is provided to shape the material extruded by the extruder 1, this material being forced, under the action of the screws 20, to pass through the outlet orifices 42.1 in the downstream direction, inwardly defined by the die 42. The embodiment of the die 42 is not limiting with respect to the invention: in particular, the number, arrangement, and more generally, characteristics of the outlet orifices 42.1 are indifferent. Likewise, non-limitingly, in the example embodiment considered here, the die 42 is equipped, at its upstream end, with a diffuser 42.2 that distributes the material, entering the die, between its outlet orifices 42.1, the inner volume, diverging in the downstream direction, of this diffuser 42.2 being, upstream, connected to the downstream end of the flow channel 43A of the module 43, and downstream, connected to the upstream end of the outlet orifices 42.1.

As clearly shown in FIGS. 2 to 4, which show only the module 43, the latter comprises a viscosity measuring sensor 43.2, which, at least in part, is arranged in the flow channel 43A so as to continuously measure the viscosity of the material flowing in this channel 43A, in other words, to perform an in-line measurement of the viscosity of the material inside the extruder 1. The sensor 43.2 can therefore be described as an integrated sensor. This sensor 43.2 in itself belongs to a known technology and is commercially available. This sensor 43.2 is designed to produce, continuously and in real time, a signal, indicated schematically by arrow S1 in FIG. 1, representative of the viscosity of the material flowing in the channel 43A from the interaction between this flowing material and the part of the sensor 43.2 arranged in the channel 43A and therefore in contact with this material. In practice, the aforementioned signal S1 is sent outside the module 43 using any appropriate means, for example a wired connection if this signal is electrical.

In practice, the integration of the sensor 43.2 and its installation in the flow channel 43A satisfy hygiene, flow and measuring constraints for the material in question to be extruded. In the example embodiment considered in the figures, the sensor 43 is securely carried by a base 43.3, which is attached, securely and sealably, in a dedicated complementary housing 43B defined by the case 43 transversely to the axis X-X. The aforementioned wired connection is, in a manner not shown in the figures, provided to join the outside of the module 43 via this base 43.3.

The module 43 also comprises a flap 43.4 for variable closing off of the flow channel 43A, which is arranged through this channel 43A so as to pivot around a geometric axis Z-Z perpendicular to the axis X-X, and therefore perpendicular to the flow direction of the material in the channel 43A. By pivoting around the axis Z-Z, the flap 43.4 makes it possible to vary the passage section of the flow channel 43A, in other words the passage section for the material being extruded in the extruder 1. In the figures, the flap 43.4 occupies a pivoting position intermediate between, on the one hand, an extreme position, not shown, with maximal closing off and therefore minimal opening, in which the plane of the flap extends globally at or close to the perpendicular to the axis X-X, and on the other hand, an extreme position, not shown, with minimal closing off and therefore maximal opening, in which the plane of the flap extends globally parallel or quasi-parallel to the geometric plane containing the axes X-X and Z-Z. Thus, by pivoting between the two aforementioned extreme positions, the passage section of the flow channel 43A varies between a maximum and a minimum, this variation of the passage section being adjustable based on the pivoted position of flap 43.4 around the axis Z-Z. It will be understood that by modifying the passage section of the flow channel 43A, one modifies the filling level of the extruder 1 accordingly upstream from the flap 43.4, and in this way, in particular the shear rate applied to the material by the screws 20 and therefore the viscosity of this material. In practice, for safety reasons, it is preferable, even in the extreme maximal closing off position, for the flap 43.3 not to completely close off the flow channel 43A in order to avoid any overpressure of the extruder 1.

The pivoted position of the closing off flap 43.4 is commanded from outside the module 43. In the example embodiment considered in the figures, the flap 43.4 is secured to a rod 43.5 driving the rotation around the axis Z-Z, which is substantially centered on this axis Z-Z and one longitudinal end of which emerges outside the module 43, i.e., upward in the figures. This rod 43.5 is mounted rotating in a complementary support 43.6, in turn received, fixedly and sealably, in a dedicated complementary housing 43C defined by the case 43.1 of the module 43. For precise control of the angular position of the rod 43.5 around the axis Z-Z, and therefore the pivoted position of the flap 43.4, this rod 43.5 is advantageously provided with an outer thread, screwed into a complementary tapping defined by the support 43.6. Furthermore, in order to reinforce the stability of the flap 43.4, the latter is, opposite the rod 43.5 along the axis Z-Z, secured to a pin 43.7, centered on the axis Z-Z and rotatably received around its axis in a complementary support 43.8, in turn attached, fixedly and sealably, in a dedicated complementary housing 43D defined by the case 43.1 of the module 43.

Of course, the embodiment of the flap 43.4 and the associated parts 43.5 to 43.8 is not limiting with respect to the invention: more generally, the module 43 is equipped with a closure member for its flow channel 43A, the variable closure action of which, resulting from its mobility in the flow channel, is adjustable, in particular from outside this module.

Furthermore, it will be noted that, in the embodiment considered in the figures, the closure flap 43.4 or, more generally, a variable closure member of the flow channel 43A is advantageously placed downstream from the viscosity measuring sensor 43.2. Although it is possible to consider, as an alternative that is not shown, the viscosity measuring sensor being downstream from the closure flap 43.4 or, more generally, a variable closure member of the flow channel 43A, the arrangement shown in the figures is preferred because in this way, the viscosity measured by the sensor 43.2 is precisely that of the material exclusively having undergone shearing by the screws 20, and not that of the material also having crossed the flap 43.4 or the closure member. In all cases, the module 43 is advantageously inserted particularly compactly between the plates 41 of the sheath 10 and the channel 42.

As shown schematically in FIG. 1, the module 43 further comprises a motor unit 60 driving the rotation of the rod 43.5 around the axis Z-Z. In practice, this driving unit 60 for example comprises an actuator of the rod 43.5, this actuator indifferently being mechanical, hydraulic or electric. In all cases, the driving unit 60 is controlled by a control unit 62 capable of sending an ad hoc control signal, indicated by arrow S2 in FIG. 1. This control unit 62 receives the signal S1 from the viscosity measuring sensor 43.2 and is designed to process this signal S1 so as to deduce the control signal S2 sent to the driving unit 60 therefrom. More globally, it is understood that, from the measurement done continuously by the sensor 43.2, the unit 62 commands, after processing the signal S1, the pivoted position of the flap 43.4 and therefore the passage section of the flow channel 43A. In other words, the control unit 62 slaves the passage section of the flow channel 43A based on the measurement provided by the sensor 43.2. There is thus a loop between the viscosity measurement of the material flow inside the extruder 1 and the passage section for this material in the extruder, more specifically in the flow channel 43A.

A method for controlling the extruder 1 described thus far with respect to FIGS. 1 to 4 is as follows. While a material to be extruded is processed by the extruder 1, the ingredient(s) of this material being introduced inside the sheath 10 via its elements 11 and 12, the viscosity of this material being extruded is measured continuously in the flow of the material inside the extruder 1, more specifically in the flow of the material inside the module 43, using the sensor 43.2. Based on the results of this measurement of the viscosity of the material being extruded, the extruder 1 is regulated so as to monitor the filling level of the sheath 10 with the material, by adjusting the passage section for the material in the extruder, more specifically by adjusting the passage section of the flow channel 43A subject to the variation of this passage section by the flap 43.4. To that end, the pivoted position of the flap 43.4 is commanded by the unit 62, via the driving unit 60 and the rod 43.5. The sensor 43.2 then measures, in real time, the viscosity changes caused by the variation, imposed by the flap 43.4, on the passage section of the flow channel 43A, thus allowing an adjustment in a closed loop between this flap 43.4 and this sensor 43.2. In practice, the calculations implemented by the control unit 62 to perform this adjustment are not limiting with respect to the invention. As an example of effective and easy slaving, the control unit 62 is designed to keep the viscosity measured by the sensor 43.2 substantially constant, the viscosity value that one thus wishes to keep unchanged being provided to this unit beforehand, for example by knowing an image of the “ideal” viscosity value beforehand for the material extruded by the extruder 1.

Rather than implementing a slaved loop like with the extruder 1 of FIGS. 1 to 4, one alternative of the method for controlling this extruder consists of adjusting the passage section for the material in the extruder manually. To that end, the corresponding extruder differs from the extruder 1 shown in FIGS. 1 to 4 by the removal of the slaved control unit 62 and the replacement of the motorized driving unit 60 with a manual control unit 60′ for controlling the rotational position of the rod 43.5 around the axis Z-Z, and therefore the pivoted position of the flap 43.4, as shown in FIGS. 5 and 6. According to this alternative, a human operator has information corresponding to the signal S1 provided by the viscosity measuring sensor 43.2, for example via a display, and, based on this information, the operator actuates the rod 43.5 by hand, owing to the member 60′. To facilitate the adjustment of the rotational position of the rod 43.5, the end of this rod, emerging outside the case 43.1, is advantageously provided with a position indicator 61′ associated with a graduated marking 61′A borne by the outer face of the case 43.1 or the support 43.6.

Taking the above considerations into account, one option of the method for controlling an extruder similar to the machine 1 consists of using one or several behavior parameters of this extruder in addition to that related to the passage section of the flow channel 43A. Indeed, the real-time measurement of the viscosity of the material being extruded, in the flow of this material inside the extruder, provides viscosity measurement results based on which this extruder can be adjusted, subject both to the adjustment of the passage section for the material being extruded downstream from the screws 20 and the adjustment of one or several additional behavior parameters of this extruder, this or these additional parameters being chosen from among:
the rotation speed of the screws 20,
the composition of the material to be extruded, in particular the nature and ratio of the ingredients of this material,
the intake flow rate of the material in the extruder, in particular the intake flow rate of each of the ingredients of this material,
the temperature imposed on the sheath 10, on the condition that the temperature is adjustable by setting out that at least one, or even each of the elements 11 to 15 of the sheath is thermo-regulated, and
the degassing intensity of the material being extruded, the sheath 10 then being equipped with specific degassing arrangements, making it possible to extract material being extruded from the gases, such as steam, for example.

Furthermore, one alternative of the method described thus far consists of the in-line viscosity measurement not at the output device 40, but at one of the elements 11 to 15 of the sheath 10, in particular the element furthest downstream 15. In other words, the continuously measured viscosity is no longer that of the material leaving the sheath, but that of the material in the sheath, in particular in the downstream part of this sheath. Of course, in this case, the extruder is, in a manner not shown in the figures, arranged accordingly: for example, a viscosity sensor, similar to the sensor 43.2, is arranged in the bore of the sheath, in particular at a zone of the screws 20, in which its or their thread is locally reduced or even eliminated in favor of a substantially smooth surface. It will thus be understood that in general, the extruder according the invention comprises in-line viscosity measuring means, i.e., means making it possible to measure the viscosity of this material in the flow of the material flowing in its sheath or in its output device, or even both, for example for measuring safety or extruder adaptability reasons.

Various arrangements and options for the extruders described thus far, as well as the control method, can also be considered. As examples:
the module 43 can be provided to be thermo-regulated subject to the integration, into its case 43.1, of an ad hoc heating/cooling systems;
in particular for supervision or safety reasons, the module 43 can be equipped with probes measuring the pressure, in particular on either side of the closure flap 43.4, and/or the temperature of the material being extruded circulating in the flow channel 43A; and/or
rather than combining the plate 41, the die 42 and the module 43, the output device 40 may not include a shaping channel; likewise, the output device 40 may not include a front plate separate from the case 43.1 subject to an appropriate arrangement of the upstream end of this case.

1-15. (canceled)

16. A method for monitoring and controlling an extruder, the extruder comprising two intermeshing screws for driving a material to be extruded, the method comprising, while a material to be extruded is processed by the extruder:
continuously measuring the viscosity of the material in a flow of said material in the extruder, and
adjusting the extruder from corresponding material viscosity measurement results, so that a material filling level of the extruder, at which the extruder is filled by the material along the intermeshing screws, is modified by adjusting, downstream from these screws, a passage section for the material based on the material viscosity measurement results.

17. The method according to claim 16,
wherein the extruder further comprises:
a sheath inside which the intermeshing screws are rotated and the material advances under the action of these screws, and
an output device, which is arranged at a downstream end of the sheath and in a flow channel of which the material leaving the sheath is forced to flow under the action of the intermeshing screws;
and wherein in order to adjust the extruder, the material filling level in the sheath is adjusted by adjusting a passage section of the flow channel.

18. The method according to claim 17, wherein the viscosity is measured for the material leaving the sheath, in the flow channel of the output device.

19. The method according to claim 16, wherein the extruder is adjusted by further adjusting, based on the material viscosity measurement results, at least one behavior parameter of the extruder chosen from among:
rotation speed of the screws,
temperature imposed on a sheath in which the driving screws are rotated,
composition of the ingredient(s), solid and/or liquid, introduced into the extruder,
flow rate of the ingredient(s), solid and/or liquid, introduced into the extruder, and
degassing of the material in the extruder.

20. The method according to claim 16, wherein the material processed by the extruder is non-Newtonian.

21. An extruder, comprising:
a sheath inside which two intermeshing screws are rotated to cause a material to be extruded to advance in the sheath,
measuring means for measuring the viscosity of the material in a flow of the material in the extruder,
an output device, which is arranged at the downstream end of the sheath and in a flow channel of which the material leaving the sheath is forced to flow under the action of the intermeshing screws, and
a varying device for varying a passage section of the flow channel so as to modify a material filling level at which the sheath is filled by the material.

22. The extruder according to claim 21, wherein the varying device comprises a closure member arranged movably in the flow channel to close off the flow channel variably.

23. The extruder according to claim 22, wherein the closure member comprises, a flap for variably closing off the flow channel, the flap being arranged across the flow channel so as to pivot around an axis substantially perpendicular to flow direction of the material in the flow channel.

24. The extruder according to claim 22, wherein the measuring means are arranged upstream from the closure member.

25. The extruder according to claim 21, wherein the varying device comprises a control unit that is slaved based on a signal provided by the measuring means.

26. The extruder according to claim 21, wherein the varying device comprises a manual control member.

27. The extruder according to claim 21, wherein the measuring means comprise a viscosity measuring sensor, which is arranged in the flow channel of the output device and which measures the viscosity of the material flowing in the flow channel.

28. The extruder according to claim 27, wherein the flow channel is defined in a dedicated modular case of the output device, which fixedly carries the viscosity measuring sensor and which carries at least part of the varying device.

29. The extruder according to claim 28, wherein the output device further comprises, at an upstream end thereof, a plate for connecting with a downstream end of the sheath, the plate being arranged upstream from the modular case.

30. The extruder according to claim 28, wherein the output device further comprises, at a downstream end thereof, a die for shaping the material leaving the output device, the die being arranged downstream from the modular case.
